(19) United States
(12) Patent Application Publication
(10) Pub. No.: US 2007/0230441 A1
(43) Pub. Date: Oct. 4, 2007

(54) System and method for optimizing throughput in a wireless network

(76) Inventors: Aseem Sethi, Bangalore (IN); Naresh Sunkara, Bangalore (IN)

Correspondence Address: FAY KAPLUN & MARCIN, LLP, 15O BROADWAY, SUITE 702, NEW YORK, NY, 10038, US

(21) Appl. No.: 11/395,554

(22) Filed: Mar. 31, 2006

(51) Int. Cl. H04L 12/66

(52) U.S. Cl. 370/352

(57) ABSTRACT

Described is a device and method for receiving a data packet, the data packet addressed to a plurality of mobile units and determining an operating mode of each of the plurality of mobile units, each of the plurality of mobile units having a first operating mode and a second operating mode. The data packet is transmitted to each of a first set of the mobile units, the first set being in the first operating mode. A signal is transmitted to a second set of mobile units, each of the mobile units in the second set being in the second operating mode, the signal including data instructing the mobile units in the second set to switch to the first operating mode within a predetermined time period. The data packet is then transmitted to the second set of mobile units after expiration of the predetermined time period.

### BACKGROUND INFORMATION

In a conventional wireless network, data may be transmitted directly from a first network device to a second network device as a unicast packet. However, at times, the data may be addressed to a group of network devices, and multiple transmissions of unicast packets may be inefficient. Thus, a multicast packet is delivered to a group address, which includes each network device in the group. If the data is directed to all of the network devices coupled to the network, the data may be transmitted as a broadcast packet. The multicast packet may be advantageous in that it requires only a single stream to transmit the data to the group of network devices. In contrast, transmission of the unicast packet to each network device in the group would require a separate stream for each network device.

According to a conventional multicast protocol, each network device in the group must receive the multicast packet at a same time. Therefore, a problem arises when one or more of the network devices is not enabled to receive the multicast packet at the time of transmission (e.g., if the network device is in a power save mode). Thus, the multicast packet must be buffered until the network device is enabled to receive the packet (e.g., switches to a wake-mode). The problem may result in substantial delays in transmission of the multicast packet to the group, and a decreased throughput of the network.

### SUMMARY OF THE INVENTION

A method for receiving a data packet, the data packet addressed to a plurality of mobile units and determining an operating mode of each of the plurality of mobile units, each of the plurality of mobile units having a first operating mode and a second operating mode. The data packet is transmitted to each of a first set of the mobile units, the first set being in the first operating mode. A signal is transmitted to a second set of mobile units, each of the mobile units in the second set being in the second operating mode, the signal including data instructing the mobile units in the second set to switch to the first operating mode within a predetermined time period. The data packet is then transmitted to the second set of mobile units after expiration of the predetermined time period.

A device having a receiving module receiving a data packet, the data packet addressed to a plurality of mobile units, a processing module determining an operating mode of each of a plurality of mobile units, each of the plurality of mobile units having a first operating mode and a second operating mode and a transmission module transmitting the data packet to each of a first set of the mobile units, the first set being in the first operating mode. The transmission module transmits a signal to a second set of mobile units, each of the mobile units in the second set being in the second operating mode, the signal including data instructing the mobile units in the second set to switch to the first operating mode within a predetermined time period. The transmission module then transmits the data packet to the second set of mobile units after expiration of the predetermined time period.

A method for receiving, at an access point, a multicast join request from a mobile unit, determining whether another access point is executing a multicast protocol, executing the multicast protocol when it is determined that another access point is not executing the multicast protocol and forwarding the join request to another access point when it is determined that another access point is executing the multicast protocol.

A device having a receiving module receiving at an access point a multicast join request from the mobile unit and a processing unit determining whether another access point is executing a multicast protocol. If the processing unit determines that another access point is not executing the multicast protocol, the access point executes the multicast protocol. If the processing unit determines that another access point is executing the multicast protocol, the access point forwards the join request to another access point.

A method for designating an access point, from a network of access points, to execute a multicast protocol, receiving, at an access point, a multicast join request from a mobile unit, determining whether the access point receiving the multicast join request is the designated access point, executing the multicast protocol when it is determined that the access point receiving the multicast join request is the designated access point and forwarding the join request to the designated access point when it is determined that the access point receiving the multicast join request is not the designated access point.

### BRIEF DESCRIPTION OF THE DRAWINGS

FIG. 1 is an exemplary embodiment of a system according to the present invention;

FIG. 2 is an exemplary embodiment of a multicast transmission method according to the present invention; and

FIG. 3 is an exemplary embodiment of a throughput optimization method according to the present invention.

### DETAILED DESCRIPTION

The present invention may be further understood with reference to the following description and the appended drawings, wherein like elements are provided with the same reference numerals. The present invention provides a system and a method for optimizing throughput of a wireless environment (e.g., a wired/wireless local/wide area network). The present invention will be described with respect to transmission of a multicast packet to a multicast group. It will be understood by those of skill in the art that data contained in the multicast packet may be, for example, voice, data, image, video, etc.

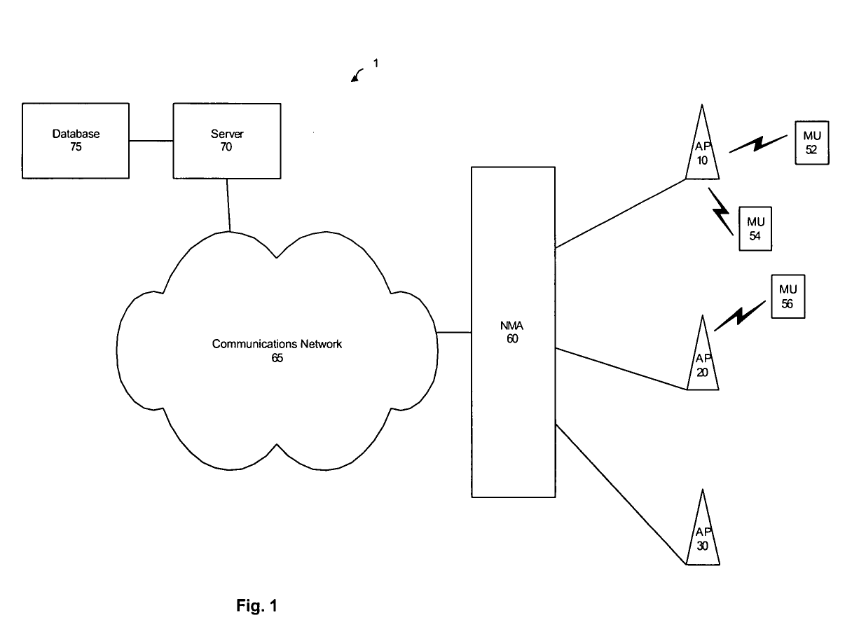

FIG. 1 shows an exemplary embodiment of a system 1 according to the present invention. The system 1 may include a network management arrangement (“NMA”) 60 coupled to a communications network 65. The NMA 60 may include one or more network computing devices (e.g., a router, a switch, etc.) for sending and receiving data over the network 65. The NMA 60 may be further coupled (directly or indirectly) to a server 70 and/or a database 75. The NMA 60 may manage the network 65 and any devices coupled thereto.

As shown in FIG. 1, the NMA 60 may be coupled to one or more access points (“APs”) 10, 20, 30 which provide a wireless connection for one or more mobile units (“MUs”) 52, 54, 56 to the network 65. Those skilled in the art will understand that the system 1 may include any number of the APs and the MUs. The APs 10, 20, 30 may be any wireless infrastructure devices (e.g., a wireless hub, a router, a switch, etc.) which provide wireless access to the network 65 for the MUs 52, 54, 56. Each MU 52, 54, 56 may be any mobile computing unit, such as, for example, an image or laser-based scanner, a radio frequency identification (“RFID”) reader, a cell phone, a laptop, a network interface card, a handheld computer, a PDA, etc.

Those of skill in the art will understand that the MU 52 may be powered by a battery. To prolong a life of the battery, the MU 52 may utilize a first mode (e.g., a power save mode) when the MU 52 is inactive (e.g., not collecting data, unable to connect to the network 65, etc.). While the MU 52 is active, it may be in a second mode (e.g., a wake mode). In the wake mode, the MU 52 may be capable of conducting wireless communication (e.g., listening for packets, sending packets, etc.).

In a conventional IEEE 802.11 network, an MU may become part of a multicast group to receive multicast packets which are addressed to the multicast group. However, the MU need not be included in the multicast group in order to transmit multicast packets to the multicast group. That is, the MU becomes part of the multicast group by selecting an AP with which to associate and sending a join request (e.g., an IGMP Membership Report) to the AP. The AP forwards the request to a server, which creates an entry for the MU in the multicast group. When the entry is created, the MU receives the multicast packets addressed to the multicast group. The server similarly creates entries for further MUs which transmit further join requests. The further MU which is not within range of the AP may also join the multicast group through a further AP. Accordingly, the further MU sends the join request to the further AP, which forwards the request to the server.

Each AP that serves one or more MUs in the multicast group executes a conventional multicast protocol, such as a Protocol Independent Multicast (“PIM”) or a Distance Vector Multicast Routing Protocol (“DVMRP”). The conventional multicast protocol, especially for voice over internet protocol (“VoIP”) transmissions, tends to consume a significant amount of bandwidth. Accordingly, as the number of APs executing the multicast protocol increases, the number of applications which may be executed on the conventional network decreases.

According to an exemplary embodiment of the present invention, a single AP (e.g., the AP 10) within the network 65 may be designated to execute the multicast protocol (e.g., PIM, DVMRP). Although only one AP 10 executes the multicast protocol, the MUs 52, 54, 56 retain the ability to join the multicast group through the APs 20, 30, which relay the join requests received to the AP 10. Thus, the AP 10 transmits the multicast packet to the APs 20, 30 in a similar manner as it would transmit the multicast packet to the MUs 52, 54, 56. The APs 20, 30 thereby act similarly to repeaters.

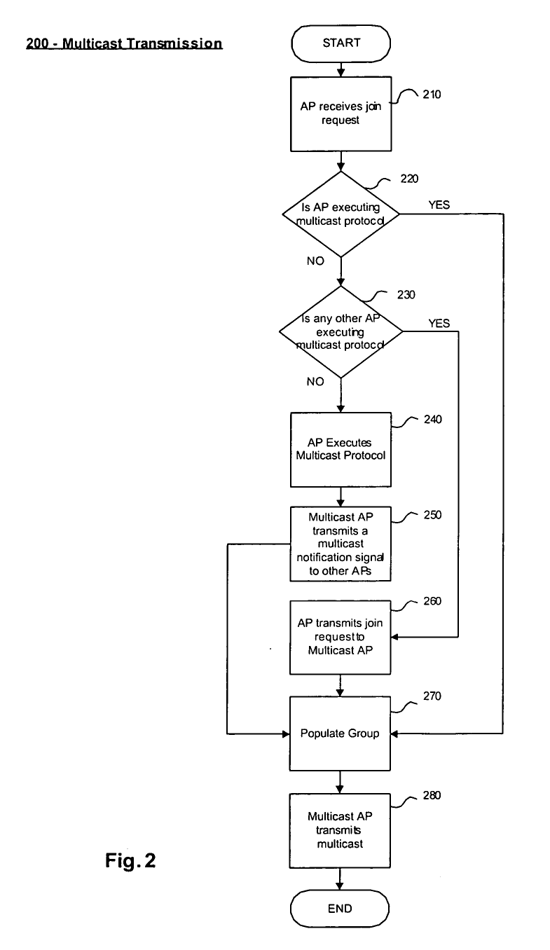

FIG. 2 shows an exemplary embodiment of a method 200 for transmitting the multicast packet according to the present invention. The method 200 will be described with reference to the system 1. In this exemplary embodiment, the AP which receives the multicast packet is the only AP which executes the multicast protocol. For example, the MU 52 may join a multicast group by transmitting a join request to the AP 10. Thus, the AP 10 may execute a multicast protocol because it received the multicast packet from the MU 52. However, after transmission of the multicast packet is complete, the AP 10 may cease running the multicast protocol and a further AP (e.g., the AP 20) may execute the multicast protocol if it receives a further multicast packet. Thus, only one AP in the system 1 executes the multicast protocol at a particular time, but every AP in the system 1 may be able to execute the multicast protocol.

However, in another exemplary embodiment, the AP which executes the multicast group may be predetermined as a function of one or more network parameters. For example, it may be predetermined that the AP with the lightest network load will execute the multicast protocol. Thus, the other APs may funnel the join requests and/or the multicast packets received thereby through the Multicast AP. Again, the predetermined AP may be a single permanent AP or the predetermined AP may switch based on current network parameters, e.g. AP loading.

The method 200 is described with reference to the embodiment where any AP may execute the multicast protocol. The modifications to the method 200 to handle other embodiments will be apparent to those of skill in the art.

In step 210, an (e.g., AP 10) receives the join request from an MU (e.g., MU 52). A further MU 54 may join the multicast group in a similar manner as the MU 52, and thus both the MUs 52, 54 receive the multicast packets addressed to the multicast group. Thus, as each MU attempts to join a multicast group, the AP receiving the request will execute the method 200. In step 220, it is determined if the AP is already executing the multicast protocol. If the AP is already executing the multicast protocol, the method continues to step 270 where the AP populates the MU into the multicast group. This step 270 will be described in greater detail below. If the AP is not executing the multicast protocol in step 220, the AP 10 will ensure that no further APs 20, 30 are executing the multicast protocol (step 230).

Thus, if the AP 10 and the other APs 20 and 30 are not executing the multicast protocol (as determined in steps 220 and 230), the AP 10 will execute the multicast protocol in step 240. In step 250, the APs 20, 30 are notified (e.g., via a wired or wireless signal) that the AP 10 is executing the multicast protocol. In one embodiment, the AP 10 may inform the NMA 60 that it is serving the multicast group. The NMA 60 may in turn inform the APs 20, 30. In another embodiment, the AP 10 may directly communicate with APs 20, 30 to inform them that it is executing the multicast protocol. In either embodiment, the APs 20, 30 recognize that the AP 10 is to serve the multicast group, and that the APs 20, 30 will not execute the multicast protocol if they receive join requests and/or multicast packets from further MUs. The AP 10 is the only AP that executes the multicast protocol, allowing the APs 20, 30 to retain a greater amount of bandwidth. Again, if the AP 10 is executing the multicast protocol, the method continues to step 270 where the AP 10 populates the MU 52 into the multicast group.

However, if in step 230 it was determined that another AP (e.g., AP 20 or 30) was executing the multicast protocol, e.g., the AP 10 previously received a notification from another AP or the NMA 60, the method continues to step 240, where the AP 10 transmits the join request received from the MU 52 to the other AP (e.g., AP 20). In one embodiment of the present invention, the AP 10 sends an additional join request indicating that it too wishes to join the multicast group. In another embodiment, the AP 20 recognizes that the join request was received from the AP 10, and therefore all multicast packets addressed to the MU 52 will be sent to the AP 10 for relaying. In either of these or further embodiments, the AP 20 adds the MU 52 to the multicast group. As discussed above with respect to step 230, the APs 10-30 may communicate either directly or through a separate medium, such as the NMA 60.

In step 270, the multicast group is populated. That is, if the AP 10 is executing the multicast protocol, the AP 10 populates the MU 52 (or any other MU) into the multicast group. However, if the AP 20 or 30 is executing the multicast protocol, that AP populates the MU 52 (or any other MU) into the multicast group. It should be noted that the multicast group may be populated by the APs and/or by the NMA 60, which manages the network 65. It will be understood by those of skill in the art that population of the group may occur at any time during a communication session. However, an MU will only receive the multicast packet while it is included in the multicast group.

In step 280, the AP executing the multicast protocol transmits the multicast packet to the multicast group. Accordingly, the multicast packet may be directly transmitted to those MUs which are associated with the AP executing the multicast protocol. The multicast packet is still received by those MUs which are associated with the further APs. However, the further APs may receive the multicast packet from the AP executing the multicast protocol, and then transmit the multicast packet to the MUs. The AP executing the multicast protocol may transmit further multicast packets to the multicast group for as long as there are still MUs included in the group and there are packets sent to the multicast group.

Thus, if the AP 10 is the AP executing the multicast protocol, AP 10 may then transmit the multicast packet to the multicast group including the MU 52. However, if another AP (e.g., AP 20) is executing the multicast protocol, the AP 20 will relay the multicast packets to the AP 10 to transmit to the MU 52. Thus, the AP 10 need not itself run the multicast protocol, and thereby saves a significant amount of bandwidth. As the AP 10 receives multicast packets from the AP 20, the AP 20 may regard the AP 10 as if it were part of the multicast group.

In a conventional 802.11 network, where at least one MU in the multicast group is in the power save mode, the AP serving the multicast group buffers the multicast packet. A delivery traffic indication message (“DTIM”) is included in a beacon sent from the AP, and received by each MU in the multicast group, including the MU in the power save mode. The DTIM indicates that the multicast packet is being buffered at the AP, and includes a DTIM interval which indicates a number of beacons which will be transmitted before the AP transmits the multicast packet. The DTIM interval is a count-down which is decremented in each successive beacon. Thus, the MU in the power save mode knows when to switch to the wake mode to receive the multicast packet.

Buffering the multicast packet, along with sending the DTIM, as described above, may cause substantial delays in delivery of the multicast packet. The delays affect each MU which is in the wake mode, because it must consume battery power for the DTIM interval. The AP must wait until all MUs in the multicast group are in the wake mode before transmitting the multicast packet. Accordingly, the throughput of the wireless network using a conventional multicast will be significantly lower when at least one MU in the multicast group is in the power save mode. Further, it is possible that the MU in the power save mode may miss the multicast packet.

According to one exemplary embodiment of the present invention, where at least one MU is in the power save mode does not adversely affect the entire multicast group. Rather, the multicast packet may be transmitted to all MUs in the group which are in the wake mode. The multicast packet may be buffered for the MU in the power save mode, while a DTIM in a next beacon indicates that the packet will be transmitted within a specified number of beacons. The MU in the power save mode receives the DTIM, and switches to the wake mode to receive the multicast packet.

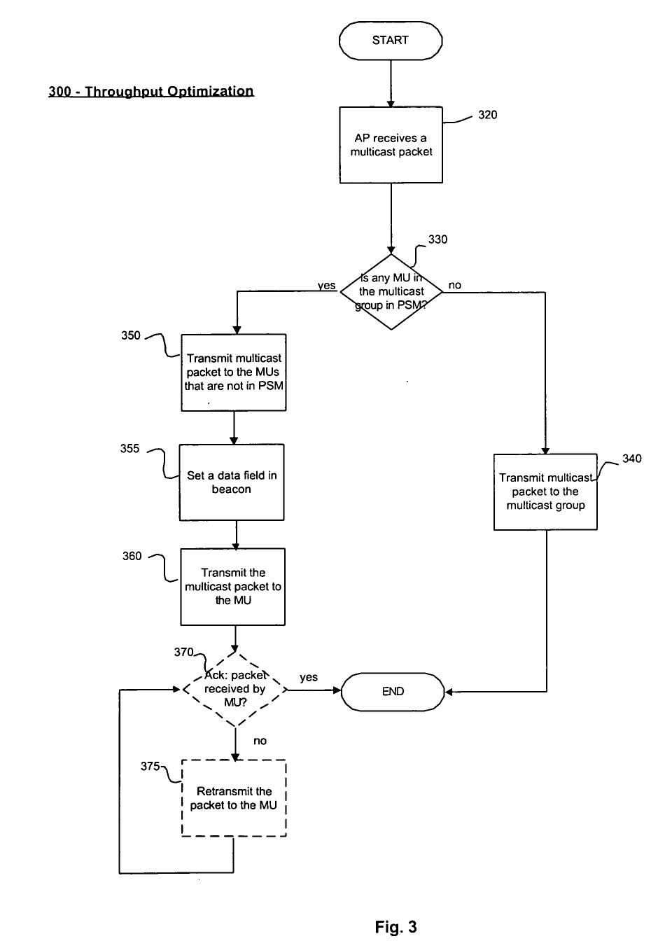

FIG. 3 shows an exemplary embodiment of a method 300 for optimizing throughput in a wireless network according to the present invention. The method 300 is particularly beneficial with respect to transmission of VoIP, because transmission of a voice packet consumes a substantial amount of bandwidth. Additionally, delays in transmitting the voice packet may result in a latency and/or permanent loss of data contained therein. However, it will be understood by those of skill in the art that the method 300 may also be employed to transmit other types of multicast packets (e.g., data, video, etc.).

Once again the exemplary method 300 will be described with reference to the exemplary network 1. The MU 52 may desire to transmit the multicast packet to the multicast group. The multicast group may include the MUs 52, 54, 56. For example, an employer using a “Push-to-Talk” (PTT) application on the MU 52 may wish to transmit instructions to select members of his crew who are using the MUs 54 and 56. Accordingly, the MU 52 transmits the multicast packet to the AP 10.

In step 320, the AP 10 receives the multicast packet. Although in the present example the multicast packet is sent by the MU 52, it will be understood that the AP 10 may also receive packets from other network entities (e.g., the NMA 60, a further AP, an MU not included in the multicast group, etc.).

In step 330, a present state of the MUs 54, 56 to receive the multicast packet is determined. That is, it is determined whether either of the MUs 54, 56 are in the power save mode. The present state of the MUs 54, 56 may be determined by the AP 10 or by the NMA 60. In an embodiment of the present invention, when the MU 54 is in the power save mode, it toggles a bit in a last frame transmitted to the AP 10. Thus, the AP 10 and/or NMA 60 may know that the MU 54 is in the power save mode. Similarly, the AP 20 and/or NMA 60 may know that the MU 56 is in the power save mode.

In step 340, it is determined that none of the MUs in the multicast group are in the power save mode, and the multicast packet is transmitted to the multicast group. The packets may be sent without buffering them at the AP 10, and delays are thereby minimized.

In step 350, it is determined that the MU 54 is in the power save mode. Accordingly, the multicast packet is transmitted to the MU 56, which is not in power save mode. Those of skill in the art will understand that other MUs which are in the wake mode may receive the multicast packet.

In step 355, the AP 10 sets a data field in a beacon to indicate to the MU 54 that the multicast packet is buffered. That is, the AP 10 will warn the MU 54 that the multicast packet will be transmitted within a specified number of beacons, e.g. the DTIM interval. Upon receiving the beacon, the MU 54 knows to switch to the wake mode within the DTIM interval in order to receive the multicast packet.

In step 360, the multicast packet is transmitted to the MU 54. In one embodiment, the multicast packet is transmitted in a similar manner as a unicast packet. That is, the multicast packet is addressed to the MU 54. The multicast packet is similarly individually addressed to any further MUs in the multicast group which were in power save mode.

In optional step 370, it is determined whether the MU 54 has received the multicast packet. In an embodiment of the present invention, the MU 54 may send an acknowledgment to the AP 10. The acknowledgment may indicate that the MU 54 has received the multicast packet.

In step 375, it is determined that the MU 54 did not receive the packet. Therefore, the multicast packet is retransmitted to the MU 54. However, because the multicast packet is addressed only to the MU 54, it is not retransmitted to the MU 56 which was in the wake mode, or to the further MUs which were in power save mode but successfully received the multicast packet.

In using the method 300 to transmit a voice packet, the voice packet may be given a higher priority than other types (e.g., image, data, etc.) of multicast and/or broadcast packets. Therefore, the voice packet is transmitted to each respective MU as soon as possible.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
receiving a data packet, the data packet addressed to a plurality of mobile units;
determining an operating mode of each of the plurality of mobile units, each of the plurality of mobile units having a first operating mode and a second operating mode;
transmitting the data packet to each of a first set of the mobile units, the first set being in the first operating mode;
transmitting a signal to a second set of mobile units, each of the mobile units in the second set being in the second operating mode, the signal including data instructing the mobile units in the second set to switch to the first operating mode within a predetermined time period; and
transmitting the data packet to the second set of mobile units after expiration of the predetermined time period.

2. The method of claim 1, further comprising determining whether each mobile unit in the second set of mobile units has received the data packet.

3. The method of claim 1, further comprising transmitting an acknowledgment from a mobile unit in the second set of mobile units after receiving the data packet.

4. The method of claim 2, further comprising re-transmitting the data packet to the second set of mobile units.

5. The method of claim 1, wherein the data packet transmitted to the second set of mobile units is individually addressed to each mobile unit in the set.

6. The method of claim 1, wherein the first operating mode is a wake mode.

7. The method of claim 1, wherein the second operating mode is a power save mode.

8. A device, comprising:
a receiving module receiving a data packet, the data packet addressed to a plurality of mobile units;
a processing module determining an operating mode of each of a plurality of mobile units, each of the plurality of mobile units having a first operating mode and a second operating mode; and
a transmission module transmitting the data packet to each of a first set of the mobile units, the first set being in the first operating mode,
wherein the transmission module transmits a signal to a second set of mobile units, each of the mobile units in the second set being in the second operating mode, the signal including data instructing the mobile units in the second set to switch to the first operating mode within a predetermined time period,
wherein the transmission module transmits the data packet to the second set of mobile units after expiration of the predetermined time period.

9. The device of claim 8, wherein the device is one of an access point and a network management arrangement.

10. The device of claim 8, wherein the signal transmitted to the second set of mobile units is included in a beacon.

11. The device of claim 8, wherein the signal transmitted to the second set of mobile units includes a delivery traffic indication message.

12. The device of claim 8, wherein the data packet transmitted to the second set of mobile units is individually addressed to each mobile unit in the set.

13. A method, comprising:
receiving, at an access point, a multicast join request from a mobile unit;
determining whether another access point is executing a multicast protocol;
executing the multicast protocol when it is determined that another access point is not executing the multicast protocol; and
forwarding the join request to another access point when it is determined that another access point is executing the multicast protocol.

14. The method of claim 13, further comprising transmitting a separate join request from the access point to another access point, when it is determined that another access point is executing the multicast protocol.

15. The method of claim 14, further comprising populating the access point into a multicast group.

16. The method of claim 13, further comprising receiving a data packet from another access point, when it is determined that another access point is executing the multicast protocol.

17. The method of claim 13, further comprising notifying other access points that the access point is executing the multicast protocol, when it is determined that another access point is not executing the multicast protocol.

18. The method of claim 13, wherein determining whether another access point is executing a multicast protocol includes directly communicating with the other access points.

19. The method of claim 13, wherein determining whether another access point is executing a multicast protocol includes communicating with the other access points through a separate medium.

20. A device, comprising:
a receiving module receiving at an access point a multicast join request from the mobile unit; and
a processing unit determining whether another access point is executing a multicast protocol,
wherein if the processing unit determines that another access point is not executing the multicast protocol, the access point executes the multicast protocol, and
wherein if the processing unit determines that another access point is executing the multicast protocol, the access point forwards the join request to another access point.

21. The device of claim 20, wherein the processing unit resides on the access point.

22. The device of claim 20, further comprising a network management arrangement communicatively coupled to the access point.

23. The device of claim 20, wherein the processing unit is included in the network management arrangement.

24. A method, comprising:
designating an access point, from a network of access points, to execute a multicast protocol;
receiving, at an access point, a multicast join request from a mobile unit;
determining whether the access point receiving the multicast join request is the designated access point;
executing the multicast protocol when it is determined that the access point receiving the multicast join request is the designated access point; and
forwarding the join request to the designated access point when it is determined that the access point receiving the multicast join request is not the designated access point.

25. The method of claim 24, wherein designating the access point is based on geographic location of the access point.

26. The method of claim 24, wherein designating the access point is based on current parameters of the network.

27. The method of claim 24, wherein designating the access point is based on a current load of each access point.

28. A device, comprising:
a receiving means for receiving a data packet, the data packet addressed to a plurality of mobile units;
a processing means for determining an operating mode of each of a plurality of mobile units, each of the plurality of mobile units having a first operating mode and a second operating mode; and
a transmission means for transmitting the data packet to each of a first set of the mobile units, the first set being in the first operating mode,
wherein the transmission module transmits a signal to a second set of mobile units, each of the mobile units in the second set being in the second operating mode, the signal including data instructing the mobile units in the second set to switch to the first operating mode within a predetermined time period,
wherein the transmission module transmits the data packet to the second set of mobile units after expiration of the predetermined time period.

29. A device, comprising:
a receiving means for receiving at an access point a multicast join request from the mobile unit; and
a processing means for determining whether another access point is executing a multicast protocol,
wherein if the processing unit determines that another access point is not executing the multicast protocol, the access point executes the multicast protocol, and
wherein if the processing unit determines that another access point is executing the multicast protocol, the access point forwards the join request to another access point.
